(19) United States
(12) Patent Application Publication
(10) Pub. No.: US 2004/0172614 A1
(43) Pub. Date: Sep. 2, 2004

(54) Dynamic code generation method

(75) Inventor: William John Gallagher, Easton, PA (US)

Correspondence Address: FLIESLER MEYER, LLP, FOUR EMBARCADERO CENTER, SUITE 400, SAN FRANCISCO, CA, 94111, US

(73) Assignee: BEA SYSTEMS, INC., SAN JOSE, CA

(21) Appl. No.: 10/712,384

(22) Filed: Nov. 12, 2003

Related U.S. Application Data
(60) Provisional application No. 60/450,987, filed on Feb. 28, 2003.

(51) Int. Cl. G06F 9/44; G06F 9/45; G06F 9/46

(52) U.S. Cl. 717/108; 717/116; 717/118; 717/148; 719/328

(57) ABSTRACT

A method for high level dynamic hot code generation. A class file container object is first created. Methods and code are then added to the class file container object. Byte code is then generated from the populated class file container object. From the byte code, instances of the new class object can by generated. The program code generator is configured to generate code at a programming language construct level, thereby working at a level of program language statements, expressions, variables, and other constructs.

### CROSS REFERENCE TO RELATED APPLICATIONS

The present application is related to the following United States patents and patent applications, which patents/applications are assigned to the owner of the present invention, and which patents/applications are incorporated by reference herein in their entirety:

United States patent application No. ______, entitled “Dynamically Generated Wrapper”, filed on XXX XX, 2003, Attorney Docket No. BEA1339us2, currently pending; and

United States patent application No. ______, entitled “Dynamic Code Generation System”, filed on XXX XX, 2003, Attorney Docket No. BEA1316us2, currently pending.

### FIELD OF THE INVENTION

The current invention relates generally to automatically generating program code, and more particularly to high level hot code generation in an object based programming language.

### BACKGROUND OF THE INVENTION

Application server systems provide an environment that allows client applications to implement services over a server network. The application server network may include vendor resources for providing services to the client applications. One such application server system is Web Logic Server, provided by BEA Systems of San Jose, Calif.

As vendor resources and application server utilities are used by client applications, it is often necessary to introduce adapters or proxies to mediate requests between clients and application server resources. A proxy is a class that has the same interface as some other class that it is taking the place of. An adapter takes the place of some class and exposes it through a different interface. A typical application server system implements a large number of proxies as resources are invoked and other services are performed. Many of these proxies require substantial amounts of code while often utilized for limited periods of time. Thus, it is not desirable to implement the interfaces for the lifetime of the application server system.

One approach is to have a user initiate code generation for the interfaces only when the interface is actually needed. In this case, a client application may run a code generation tool to statically generate a java file and compile the java file into a class file. The user then makes the class available to the Java virtual machine. This approach is undesirable because it requires a user to manually perform many steps to generate the code.

Another method for generating interfaces involves Java dynamic proxies. Java dynamic proxies require that an interface and an invocation handler be provided by a user. In return, the Java dynamic proxy generation system provides a class that will forward invocations to the invocation handler. Java dynamic proxies are limited in the types of classes that they generate. It is not possible, for example, to generate a class that is a subclass of a user defined class. Another problem with dynamic proxies is that they are not as efficient as dynamic code generation. To implement many types of proxies, it is often necessary to use reflection within the invocation handler. Reflection is not as efficient as early bound invocation. There is also a cost associated with the way that dynamic proxies marshal the arguments for an invocation into an object array.

What is needed is an improved system and method for generating program code at runtime for any type of class.

### SUMMARY OF THE INVENTION

The present invention includes a method for high level dynamic hot code generation. A class file container object is first created. Methods and code are then added to the class file container object. Byte code is then generated from the populated class file container object. From the byte code, instances of the new class object can by generated. The program code generator is configured to generate code at a programming language construct level, thereby working at a level of program language statements, expressions, variables, and other constructs.

### BRIEF DESCRIPTION OF THE DRAWINGS

FIG. 1 is an illustration of a method for automatically generating program code in accordance with one embodiment of the present invention.

### DETAILED DESCRIPTION

The automatic program code generator of the present invention provides a high level means to dynamically generate code. The program code generator is configured to generate code at a programming language construct level, thereby working at a level of program language statements, expressions, variables, and other constructs. The code generation can occur as part of a stand-alone application or within the application server process. Typically, the code generated would be configured to exist for the life of the server. In one embodiment, the code generated could be configured to last for some time shorter or longer than the server it resides on, depending on the application and scope of the code generated.

In one embodiment, the Java based automatic program code generator may be used to generate code for any type of Java program. The invention is especially useful when used to build efficient adapters and proxies. Applications of the Java automatic code generator include but are not limited to remote method invocation (RMI) skeletons, RMI stubs, wrappers for JDBC connections, and proxies used to enforce call-by-value semantics between EJBs, the latter of which are applied to copying parameters. Typically, the code implementing a proxy or adaptor is dynamically generated when the code is needed, such as when a remote method is invoked on a resource. However, the dynamic code generation of the present invention may occur at any time depending on the particular application and resource available.

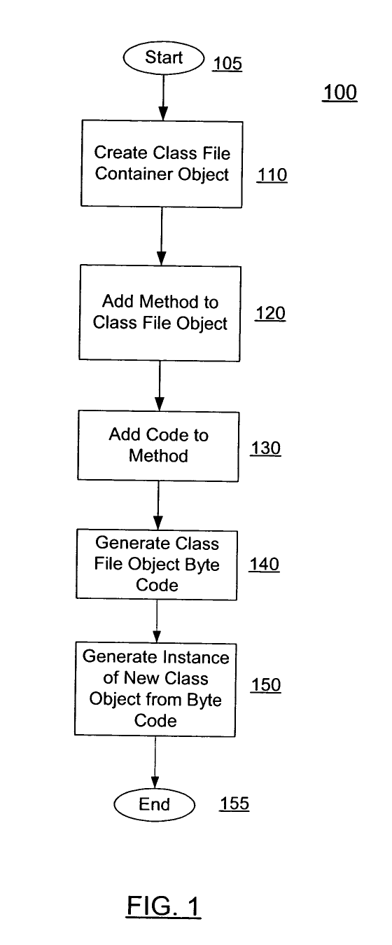

An API may be used to define a method or code in the method that will comprise the class file container object. FIG. 1 illustrates a method 100 for automatically generating program code in accordance with one embodiment of the present invention. Method 100 begins with start step 105. Next, a class file container object is created in step 110. The class file container object is a representation of a class file. In one embodiment, creating a class file container object includes setting attributes for the class file. The attributes may include the class file name, parent super class, and other attributes.

A method is then added to the class file object at step 120. At generation, the method is empty and contains no code. Step 120 may be repeated several times depending on the number of methods that will be contained within the class file. For example, for a stub generated for a remote object, the stub may include several methods. In this case, for each method in the remote interface, a method would be added to the new class file container object. Code may then be added to the method at step 130. In one embodiment, code is added to a method using constructs that correspond to Java language statements, expressions, variables, or any other programming elements. Each of these constructs may include parameters as necessary.

Steps 120-130 generate a tree of statements and expressions. The tree represents at least one method containing at least one code statement, expression, variable, or other programming construct.

When the class file container is to be a known type, such as a proxy or adapter, the tree may form a known structure or interface. The organization of the objects in a particular structure or interface avoids the need for a compiler. In one embodiment of the present invention, each statement or expression type is represented as an object. The assembling of received objects into new class objects may be modified to fulfill specific program code implementations and applications.

After the class file container object methods and code have been added, Java bytecode may be generated at step 140. In operation, each statement maintains the state of the program being generated. The maintained state includes, among other things, the contents of the stack and the contents of the local variables that are in use at each point of the program flow. The statement uses this state to generate an intermediate representation of the program flow that consists of Java objects that represent individual bytecode instructions. A bytecode assembler converts the intermediate representation into bytecode that can be interpreted by a Java virtual machine.

After generating the byte code for the class file container object, an instance of the new class file object may be generated at step 150. Operation of method 100 then terminates at step 155. A class loader can be used to generate executable code from the generated byte code.

A pseudo code example of the API used to generate code as discussed above is shown below. Line numbers 201-206 are illustrated for reference purposes only.

| import java.io.*; | | 201 |
|---|---|---|
| import java.lang.reflect.*; | | |
| import weblogic.utils.classfile.*; | | |
| import weblogic.utils.classfile.expr.*; | | |
| public class gen { | | |
| public static void main(String[] args) throws Exception | | |
| { | | 210 |
| | FileOutputStream fos = new FileOutputStream(“MyClass.class”); | |
| | ClassFile classFile = new ClassFile( ); | 213 |
| | classFile.setClassName(“MyClass”); | |
| | classFile.setSuperClassName(“java.lang.Object”); | |
| | // adds the method: | |
| | // public static void main(String[] s) { ... } | |
| | MethodInfo methodHandle = | |
| | 219 | |
| | classFile.addMethod(“main”, “([Ljava/lang/String;)V”, | 220 |

Modifier.PUBLIC | Modifier.STATIC);

Field f = System.class.getField(“out”);
Method m =
PrintStream.class.getMethod(“println”, new Class[] {

String.class}
);

| | Expression[] arguments = new Expression[] { Const.get(“Hello | |
|---|---|---|
| World!”) }; | | 230 |
| | CompoundStatement code = new CompoundStatement( ); | |
| | // add the code: | |
| | // System.out.println(“Hello World!”); | |
| | code.add(new InvokeExpression(f, m, arguments)); | 236 |
| | // add the code: | |
| | // return; | |
| | code.add(new ReturnStatement( )); | 240 |
| | methodHandle.setCode(code); | |
| | 242 | |
| | classFile.write(fos); | 244 |

}
}

In the pseudo code above, the class file container object is generated using the ClassFile statement at line 213. A method is added using the addMethod (NAME, DESCRIPTOR, MODIFIERS) method, wherein the NAME is the name associated with the method. At line 220, the NAME is “main”. Information regarding the method “main” is provided at line 220 in the parameters DESCRIPTOR and MODIFIERS. The “addMethod” method returns a handle to the method called “methodHandle”. Code is then compiled into a list of statements using the statements at lines 236 and 240. The code is associated with a particular method using a methodHandle.add( ) statement, wherein methodHandle refers to the method added at line 219. Code is added to a method using a methodHandle.setCode (XXX) format, wherein “methodHandle” is a handle to the method to populate with code and XXX identifies the code. In the pseudo code above, the statement method.setCode (code) adds two lines of code tagged with “code” to the method “method”. The class file is then written using a classFile.write (YYY) format, wherein the YYY represents the file output stream.

import java.io.PrintStream;
public final class MyClass
{

public static void main(String args[])
{

System.out.println(“Hello World!”);

}

}

The class above is a simplified example that is configured to generate text that reads, “Hello World!”. The pseudo code above illustrates code for generating two types of expressions, an invoke expression and a return statement. This illustration is for illustrative purposes only. Other expressions, statements, variables, and other programming constructs are within the scope of the present invention. These programming constructs may include, but are not limited to, switch statements, array expressions (such as an expression allowing one to index into an array), cast expressions (allowing a cast from one object type to another), compound statements (a list of statements), conditional expressions (including Boolean expressions), constant expressions (for all primitive programming types), invoke expressions (for invoking methods on different types of objects), expressions that represent local variables of a method, and expressions for creating new objects and arrays. In one embodiment, the code generation tool of the present invention may be configured to include an expression that represents each Java programming expression and a statement that represents each Java programming statement.

Dynamic code generation can be used to implement an adaptor class in a similar manner to that discussed above. In this embodiment of the present invention, the generated adapter class that may look like the code shown below.

interface Foo
{

public void bar( );

}
FooProxy implements Foo
{

FooImpl delegate;
public void bar( ) {

// perform some pre-processing
// invoke
delegate.bar( );
// perform some post-processing

}

}

As will be understood by those in the field of programming, this is much more efficient than using an invocation handler with Dynamic Proxies.

Other features, aspects and objects of the invention can be obtained from a review of the FIGUREs and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention, including, but not limited to, assembling class file objects, generating a parse tree, instantiating class file objects, and generating byte code.

1. A method for automatically generating program code, comprising:
creating a class file container object;
adding a method to the class file object;
adding code to the method;
generating Java byte code for the class file container object; and
generate an instance of the new class file object.

2. The method of claim 1 wherein creating a class file container object includes:
setting attributes for a class file.

3. The method of claim 2 the attributes include at least one of class file name, parent super.

4. The method of claim 1 wherein adding a method to the class file object includes:
adding a plurality of methods to the class file object.

5. The method of claim 1 wherein adding code to the method includes
adding code to the method using constructs that correspond to programming language statements, expressions, and variables.

6. The method of claim 5 wherein the constructs include parameters.

7. The method of claim 5 wherein each statement, expression type, variable is represented as an object.

8. The method of claim 1 wherein generating Java byte code for the class file container object includes:
generating an intermediate representation of program flow.

9. The method of claim 8 wherein generating Java byte code for the class file container object includes:
converting the intermediate representation into byte code.

10. The method of claim 1 wherein the program code implements an adaptor class.

11. The method of claim 1 wherein the program code implements a proxy class.
